(19) United States
(12) Patent Application Publication
(10) Pub. No.: US 2020/0408192 A1
(43) Pub. Date: Dec. 31, 2020

(54) VERTICAL AXIAL WIND POWER GENERATOR

(71) Applicant: HONG XING TECHNOLOGY CO., LTD., Taipei (TW)

(72) Inventors: Shigeru ANDO, Taipei (TW); Rang-Rong CHANG, Taipei (TW)

(21) Appl. No.: 16/911,881

(22) Filed: Jun. 25, 2020

(30) Foreign Application Priority Data
Jun. 28, 2019 (TW) 108122951
Apr. 24, 2020 (TW) 109113899

(51) Int. Cl. F03D 3/06; F03D 3/00; F03D 9/25

(52) U.S. Cl. CPC F03D 3/061; F03D 3/005; F03D 3/064; F03D 9/25; F05B 2260/404; F05B 2240/211; F05B 2240/12; F05B 2240/50; F03D 3/068

(57) ABSTRACT

A vertical axial wind power generator including blades rotated in a horizontal direction, and each blade includes inner and outer wind collection vanes, so that the blades can be operated without being limited by space and environment and can be rotated vertically by tiny wind. When wind power is lower than magnetic force of magnet on the blades and fastening disks, the blades enters an open status to increase windward area; when wind power is higher than the magnetic force, centrifugal force can force the blade to close to become a ball type, and blades of the ball type can have strong torsion effect, and only the windward area of the outer wind collection vane receive wind, so that rotation speed of the wind power generator can be stable. When wind power becomes weak, the blades can be rotated reversely to the open status.

This application claims the priority benefit of Taiwan patent application numbers 108122951 and 109113899, filed respectively on Jun. 28, 2019 and Apr. 24, 2020.

### BACKGROUND OF THE INVENTION

### 1. Field of the Invention

The present invention relates to a vertical axial wind power generator, more particularly to a small and medium-sized wind power generator, wherein the wind power generator includes a plurality of blades disposed thereon and rotated in a horizontal direction, the horizontal blades can be operated with less limitation in space and environment, and the wind power generator can be rotated by low wind power.

### 2. Description of the Related Art

A large part of progress of industrial technology can be attributed to the invention of electricity. Electricity can be used by ordinary households and industries, and the global electricity consumption is growing almost every year because of the rise of various manufacturing industries and the pursuit of smart home appliances, and it causes a huge power gap. The main sources of traditional electricity in various countries include thermal power generation and nuclear power generation. Thermal power generation must consume a lot of fuel, and is bound to cause the depletion of fuel resources and great air pollution. The nuclear power generation is the most efficient energy source for power generation. However, the global nuclear energy disasters have occurred accidentally, so people's fear of nuclear energy has been strengthened, the anti-nuclear sound has risen, and many countries take effort in finding alternative energy to replace the aforementioned two main energy sources.

Alternative energy, also known as green energy, is to use various forces of the natural environment to drive power generators or store electricity. Green energy mainly includes solar energy, wind power, water power and sea-wave power. The wind power system can capture wind power to drive blades to rotate, and the mechanical energy generated by the rotation is converted into electrical energy by the generator. Generally, the structure of a large-sized horizontal axial wind power generator is a towering support column, and then a vertical cross-shaped fan blade is arranged on the upper end of the support column. The fan blade can be driven to rotate by strong wind only. However, the large-sized wind power generator cannot be popularized because of large size, high cost and limited installation location (mostly by the sea or windy areas). Furthermore, the blades of this large-sized wind power generator are fixed and cannot be adjusted with the wind direction. When the wind is too strong, the wind power generator must stop operating to prevent the rotate speed of the wind power generator from exceeding the rated speed to damage the power-generator because of too strong wind. For this reason, the large-sized wind power generator cannot operate under too strong wind; when the wind conditions do not match, the large-sized wind power generator cannot be operated, and it directly affects the efficiency of power generation. Seasonal and climate changes are the biggest variables of green energy. Therefore, how to develop a wind power generator capable of being less affected by external environment is a key issue in the industry.

Please refer to FIG. 1, which shows a structural view of a conventional wind power generator. The conventional wind power generator mainly includes wing-type blades 1, a rotation shaft 11, a support beam 12, a power generator group 13 and a vertical tower support 14. In the wind power generator, the power generator group 13 is combined to a top of the vertical tower support 14, and the wing-type blades 1 are disposed on the periphery of the rotation shaft 11 in a radial arrangement, and each wing-type blade 1 is in a curved-wing shape, and a length direction of the rotation shaft 11 is perpendicular to a travel direction of wind. When the wing-type blades 1 are blown by wind, the rotation shaft 11 can be driven to rotate to drive operation of the power generator group 13. However, the wind direction of the monsoon varies with the season, and when the wing-type blades 1 cannot be adjusted in response to the change of the wind direction, the wing-type blades 1 is often operated under the pushing force in the skew wind direction, and it is easy to make the wing-type blades 1 damage and fatigue to cause aging and other problems subject to abnormal stress. On the other hand, the size and design of the general wing-type blade 1 are fixed, and it causes that the area of the wing-type blade 1 is not large enough to receive wind when wind speed is low, and the power generator group 13 fails to operate fully. Secondly, the mechanical energy provided by the wind power generator to the power generator group 13 is increased as the wind speed increases. When the wind power generator encounters the wind with speed higher than blast degree (>14 m/s), the wind power generator must stop rotating or the windward angles of the blades must be adjusted in order to prevent from the power generator group 13 and the charging system from being damaged. For most wind power generators, the rated wind speed is set at about 12 m/s, and the wind speed at which power generation must be stopped is set at about 15 m/s, and the difference between these wind speeds is not large; when the wind power generator encounters a strong wind and is expected to generate power at full speed but the wind power generator is often stopped to prevent over-speed rotation, it affects the power generation efficiency and total power generation. Therefore, in order to solve the above-mentioned problems about the strength of the wing-type blade 1 and the stability performance of the power generator group 13, the inventors of the present invention develop a wind power generator with lightweight, high-strength and time-saving process, and the wing-type blade 1 of the wind power generator can receive the wind energy to generate good mechanical energy under lower-speed wind, and the wind resistance of the wing-type blade 1 can be adjusted along with increasing of the wind speed, the matching of the wind power generator and the power generator group 13 can be adjusted within a safety range by automatically controlling the rotation speed within a preset rotation speed range no matter under breeze or strong wind, so as to reach the purpose of protecting the wind power generator and improving the efficiency and lifetime of the wind power generator.

### SUMMARY OF THE INVENTION

Therefore, in order to solve the conventional problems, the inventors develop the wind power generator according to collected data, multiple tests and evaluations, and years of research experience.

An objective of the present invention is to provide a vertical axial wind power generator, and the wind power generator includes a plurality of blades disposed thereon and rotated in a horizontal direction, the horizontal blade can be operated with less limitation in space and environment during operation, and can be rotated by low wind power; a first fastening disk is disposed under a first opening of the plurality of blades, and connected to each blade through a rotation support column; a second fastening disk is disposed above a second opening, and connected to each blade through a rotation support column; each blade is swingable curvedly between the first fastening disk and the second fastening disk; the main body is supported by three screw rod cylinders, a square-tube triangular plate and a circular band, and the circular band is used to hold the three screw rod cylinder to secure the main body, so as to prevent shaking because of uneven torque, the blades can be adjusted to receive the wind power, thereby achieving the purpose of protecting the wind power generator mechanism and extending lifetime of the wind power generator.

Another objective of the present invention is that each blade has an inner wind collection vane disposed on an inner side thereof and configured to increase the windward area when the blades are opened, the improved structures of blades can increase starting torque by intercepting wind, to generate good mechanical energy under lower wind speed, thereby achieving the effect of quickly operation under breeze.

Another objective of the present invention is that each blade has an outer wind collection vane disposed on an outer side thereof and configured to maintain the windward area of the blades in a closed status and constant-speed operation time, so as to achieve the purpose of protecting the wind power generator mechanism and extending efficiency and lifetime of the wind power generator.

Another objective of the present invention is that the rotation column includes a magnet embedded on a top thereof, and each of the first fastening disk and the second fastening disk includes a magnet embedded thereon, and in the angle-limiting groove of the first fastening disk and the second fastening disk, a first magnet is embedded in an outer hole near the outer circumference and configured to repel the magnet embedded on the rotation column of the blade, a second magnet is embedded in an outer hole near the center of the fastening disk and configured to attract the magnet on the rotation column of the blade, so that the repel force and attraction force of the first and second magnets can be used to assist the plurality of blades to rotate and suppress the plurality of blades from generating over-speed rotation, thereby making the plurality of blades automatically open or close stably at the same time.

Another objective of the present invention is that each of the blade comprises a third magnet group with the same polarities embedded thereon, the outer circular band of the wind power generator includes a fourth magnet group with staggered polarities (that is, the N-pole magnet and S-pole magnet are arranged in a staggered manner), to generate a magnetic-field resultant force of attraction and repulsive forces between the third magnet groups and the fourth magnet groups, which is similar to the operational principle of a motor, to assist the plurality of blades to generate starting rotation under breeze and suppress the plurality of blades from generating over-speed rotation under strong wind.

Another objective of the present invention is that when the wind power is lower than the magnetic forces of the magnets on the blades, the blades can enter an open status to increase windward area; when the wind power becomes higher than the magnetic force, the blades are closed to form a ball type, to provide effect of strengthening torque, and at this time, the windward area of the blades is minimized, so the rotation speed of the wind power generator can be reduced naturally; next, after the wind speed becomes stable, the plurality of blades can return to the open status; furthermore, left and right lateral sides of each blade have different weights, so that the plurality of blades can be simultaneously opened or closed stably in response to the rotation speed of the wind power generator. Therefore, by using the physical effect, such as the weight difference between the left and right lateral sides of the blade, the air flow pressure difference between inner side and outer side of the blade, the centrifugal force, and the attraction force and the repulsive force of the magnet, the plurality of blades can be automatically opened and closed stably in a lone time during rotation of the wind power generator, and in the closed status, the blade can stop a part of windshield function to decrease the pushing force for rotating the main shaft, thereby achieving the purpose of securely operating continuously under excessive wind power.

### BRIEF DESCRIPTION OF THE DRAWINGS

The structure, operating principle and effects of the present invention will be described in detail by way of various embodiments which are illustrated in the accompanying drawings.

FIG. 1 is a whole structural diagram of a conventional wind power generator.

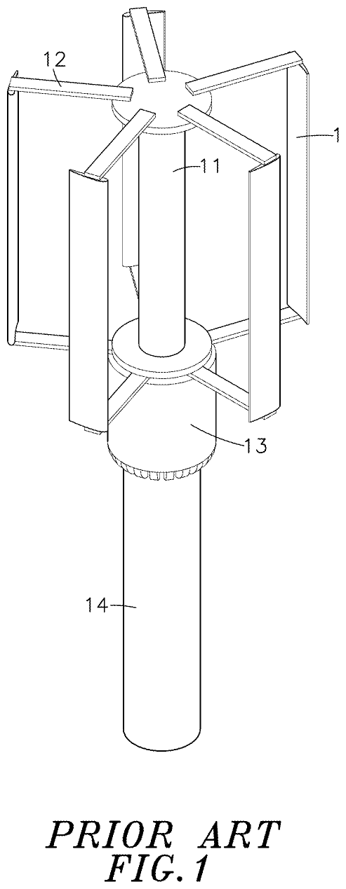

FIG. 2 is a structural diagram of a wind power generator of the present invention.

FIG. 3 is a top view of opened blades of a wind power generator of the present invention.

FIG. 4 is a top view of closed blades of a wind power generator of the present invention.

FIG. 5 is a perspective view of the closed blades of the wind power generator of the present invention.

FIG. 6 is a structural diagram of a first fastening disk of the present invention.

FIG. 7 is a structural diagram of a second fastening disk of the present invention.

FIG. 8 is a structural diagram of a framework of a wind power generator of the present invention.

FIG. 8A is a structural diagram of components of a circular band of a wind power generator of the present invention.

FIG. 8B is a structural diagram of an assembly of a wind power generator of the present invention.

FIG. 9 is a top view of an opened impeller and a circular band of a wind power generator of the present invention.

FIG. 10 is a top view of a closed impeller and a circular band of a wind power generator of the present invention.

FIG. 11 is an exploded view of a wind power generator of the present invention.

FIG. 12 is a schematic view of different statuses of elliptic impellers of a wind power generator of the present invention.

FIG. 13 is a structural diagram of a plurality of windmill units serially connected to each other, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

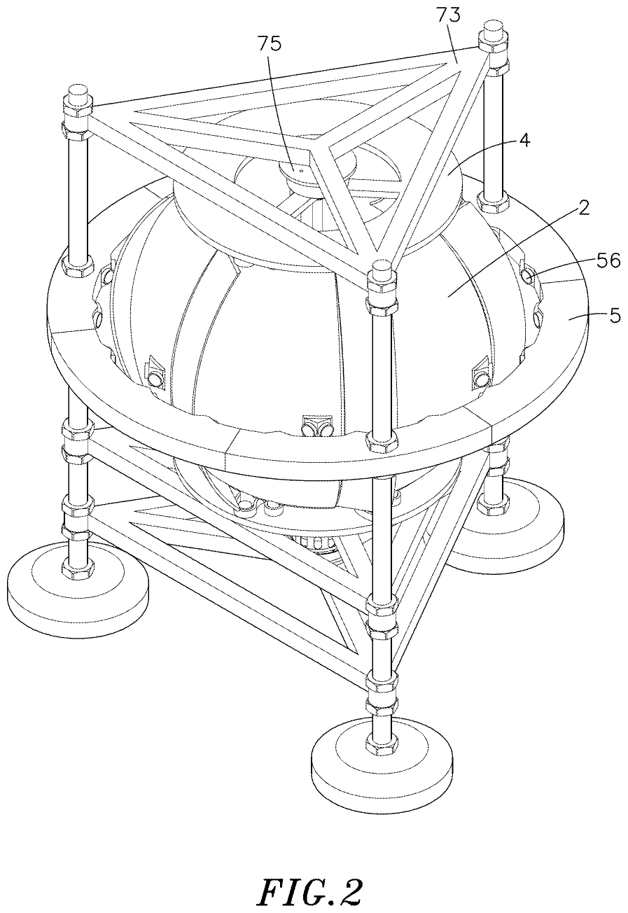

Please refer to FIGS. 2 to 13, which show a structural diagram of a wind power generator, a top view of opened blades of the wind power generator, a top view and a perspective view of closed blades of the wind power generator, a structural diagram of a first fastening disk, a structural diagram of a second fastening disk, a structural diagram of a framework of the wind power generator, a structural diagram of components of a circular band of the wind power generator, a structural diagram of assembly of the wind power generator, a top view of opened impeller and the circular band of the wind power generator, a top view of closed impeller and the circular band of the wind power generator, an exploded view of the wind power generator, a schematic view of different statuses of elliptic impellers of the wind power generator, and a structural diagram of a plurality of windmill units serially connected to each other. As shown in FIGS. 2 to 13, the vertical axial wind power generator of the present invention mainly includes a power generator 6 which can use wind power to drive a transmission shaft 62 to generate electrical power. Details of components and connection relationships of the wind power generator of the present invention are described in following paragraphs.

Please refer to FIG. 2, which is a structural diagram of a wind power generator of the present invention. The wind power generator includes a plurality of blades 2 disposed thereon and can be rotated in a horizontal direction. The plurality of blades 2 are disposed outside the transmission shaft 62 of the power generator 6 and can be rotated by the wind power, to drive the transmission shaft 62. The plurality of blades 2 can be operated with less limitation in space and environment, and can be rotated by low wind power. A first fastening disk 3 is disposed on bottom side of a first opening under the plurality of blades 2, and connected to each blade 2 through a rotation support column 23; a second fastening disk 4 is disposed on a top side of a second opening above the plurality of blades 2, and connected to each blade 2 through the rotation support column 23, and each blade 2 is swingable curvedly between the first fastening disk 3 and the second fastening disk 4. The main body of the wind power generator is supported by three screw rod cylinders 77, three square-tube triangular plates 71, 72 and 73, and a circular band 5. The function of the circular band 5 is to encircle the three screw rod cylinders 77 to secure the main body of the power generator, so as to solve the shaking problem caused by uneven torque. Furthermore, the blades 2 can be adjusted to meet and receive the wind power, so as to achieve the purpose of protecting the wind power generator and extending lifetime of the wind power generator.

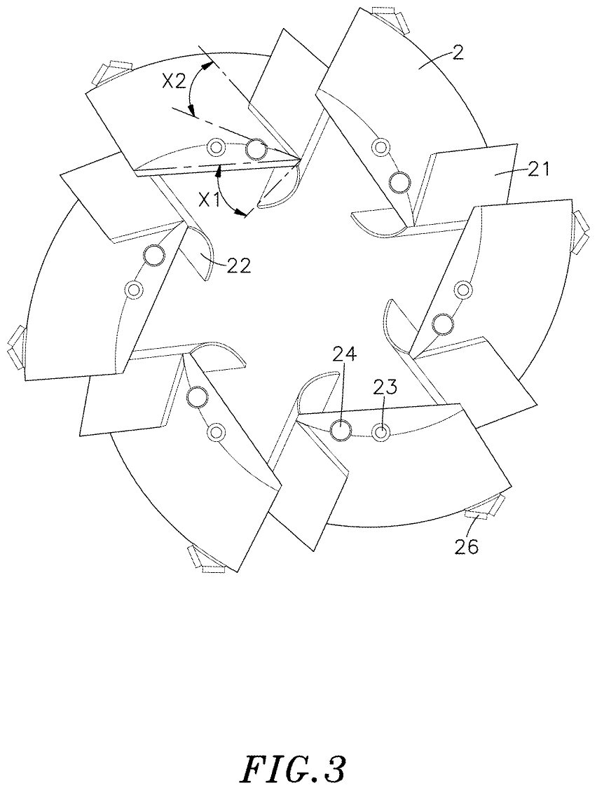

Please refer to FIGS. 3 to 7. Two cylinders are assembled with each of the plurality of blades 2, one is the rotation support column 23 and the other is a rotation column 24. Two ball bearings 35 and 45 are mounted on two ends of the rotation support column 23, respectively, so that the rotation support column 23 can smoothly perform a circle rotation, and the rotation column 24 can be curvedly swung in angle-limiting grooves 31 and 41 of the first and second fastening disks 3 and 4. The rotation column 24 can include a magnet embedded on a top thereof, and the first fastening disk 3 and the second fastening disk 4 can include magnets embedded thereon, respectively. In the angle-limiting groove 31 of the first fastening disk 3, a first magnet 33 is embedded in an outer hole near the outer circumference to repel the magnet embedded on the rotation column 24 of the blade 2, a second magnet 34 is embedded in an inner hole near the center, to attract the magnet on the rotation column 24 of the blade 2, so that the repel force and attraction force of the first and second magnets 33 and 34 can be used to assist the plurality of blades 2 to rotate, and suppress the plurality of blades 2 from generating over-speed rotation. As a result, the plurality of blades 2 can be automatically opened or closed stably at the same time.

Please refer to FIG. 3, which is a top view of opened blades of the wind power generator of the present invention. In order to make the plurality of blades 2 rotate effortlessly under wind, each blade 2 has an inner wind collection vane 22 disposed on an inner side of the most front end thereof in a rotational direction, and the inner wind collection vane 22 can receive wind similarly to a sail of a sailboat, so as to obtain power in efficiently forward direction. With configuration of the inner wind collection vane 22, the energy of the wing flowing into the wind power generator through the openings of the plurality of blades 2 can be captured, so that the plurality of blades 2 can generate torque to rotate effortlessly. When the plurality of blades 2 are opened, the structure of capturing wind energy can increase the windward area for activating torque, so when the surrounding environment of the wind power generator is in a weak-wind status, the plurality of blades 2 can still be driven to rotate. In this embodiment, an angle X1 between the inner wind collection vane 22 and the inner side of the blade can be in a range of 10 degrees to 60 degrees, the size of the inner wind collection vane 22 can be determined upon the curve size of shape of the blade 2. The structure and angle of the inner wind collection vane 22 is based on Bernoulli's principle, the inner wind collection vane 22 can be moved from a position with high wind pressure and high flow rate to a position with low wind pressure and low flow rate, so that the blade 2 can be rotated by wind more effortlessly. The mounting angle of the inner wind collection vane 22 is a key feature of the wind power generator of the present invention, and the mounting angle of the inner wind collection vane 22 is a key factor affecting the wind receiving amount of the blade 2 of the wind power generator, preferably, the mounting angle of the inner wind collection vane 22 of the wind power generator of the present invention can be set as 50 degrees; however, the scope of the present invention is not limited to the preferred example.

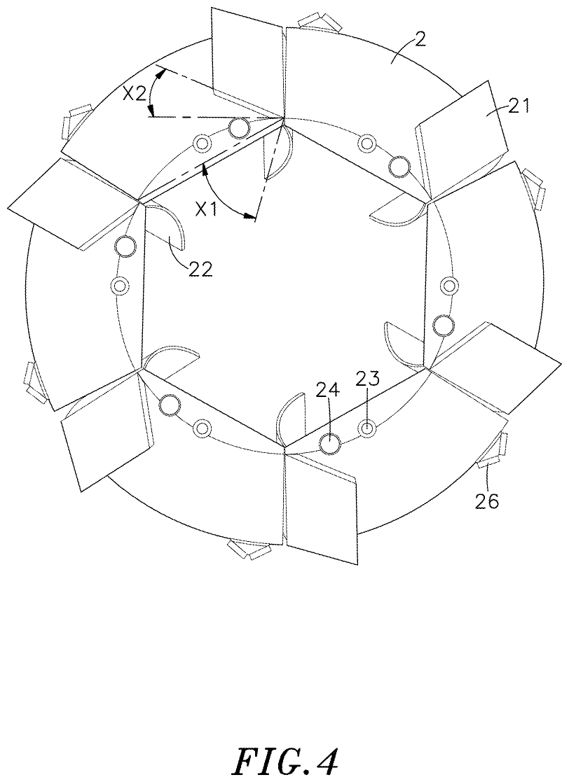

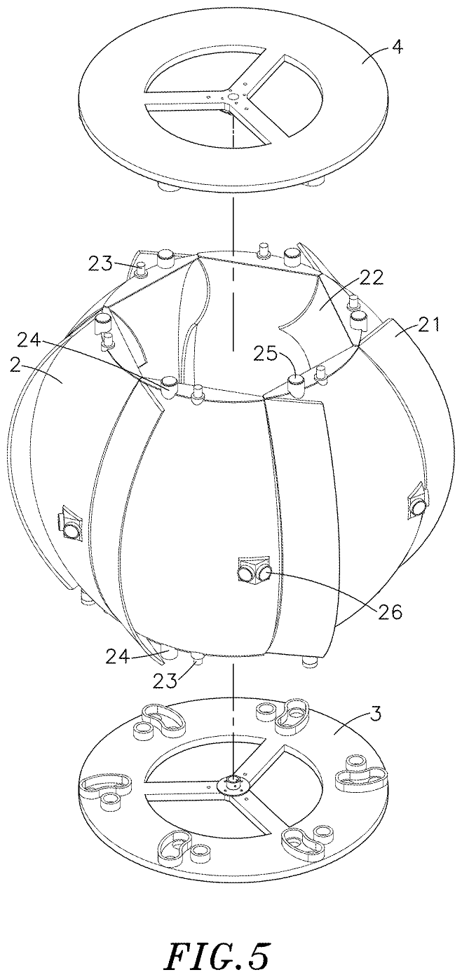

Please refer to FIGS. 4 and 5, which are a top view and a perspective view of the closed blades of the wind power generator of the present invention. Each of the plurality of blades 2 has an outer wind collection vane 21 disposed on an outer side thereof, a range X2 between the outer wind collection vane 21 and the outer side of the blade 2 can be in a range of 10 degrees to 60 degrees. The outer wind collection vane 21 can have a rectangular arc-shaped plate body and be used to increase the windward areas of the closed blades 2 and maintain the closed time of the blades 2, in order to prevent the plurality of blades 2 of the wind power generator from being opening because of failure of keeping rotational speed under strong wind, and to prevent the inner mechanisms from being blown to damage by the strong wind. Before the wind becomes slow, when the wind power generator can be rotated continuously in a ball type, it ensures that the wind power generator can continuously generate power and keep safe rotation. In windless or breeze situation, the outer wind collection vanes 21 on outer sides of the blades 2 can enable the wind power generator to rotate more effortlessly to keep the wind power generator in high-speed rotation, so that the wind power generator can be continuously rotate in the ball-type status. The outer wind collection vanes 21 of the plurality of blades 2 are used to receive appropriate wind pressure in the ball type when the wind power generator is in high-speed rotation, thereby achieving the purpose of continuous safe rotation. Preferably, the mounting angle of the outer wind collection vane 21 of the wind power generator of the present invention is set as 30 degrees; however, the scope of the present invention is not limited to the preferred example.

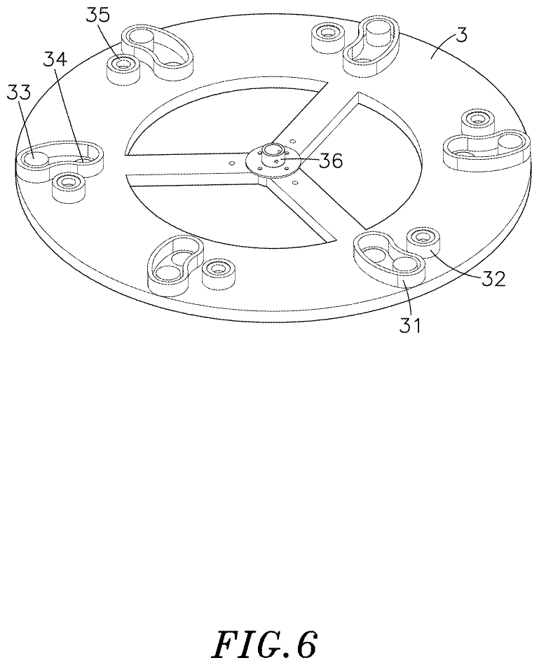

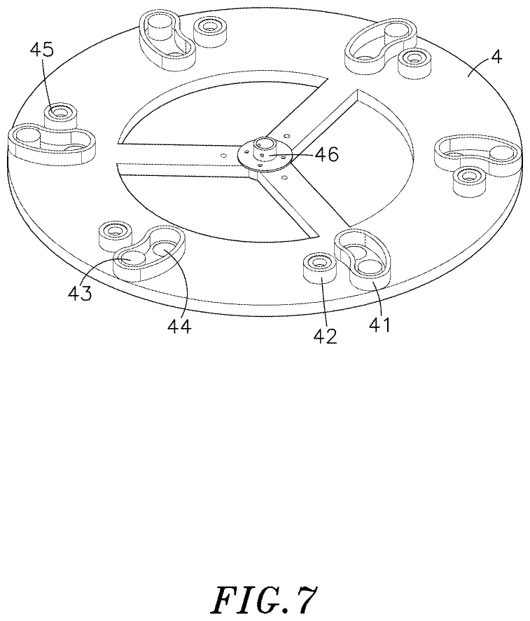

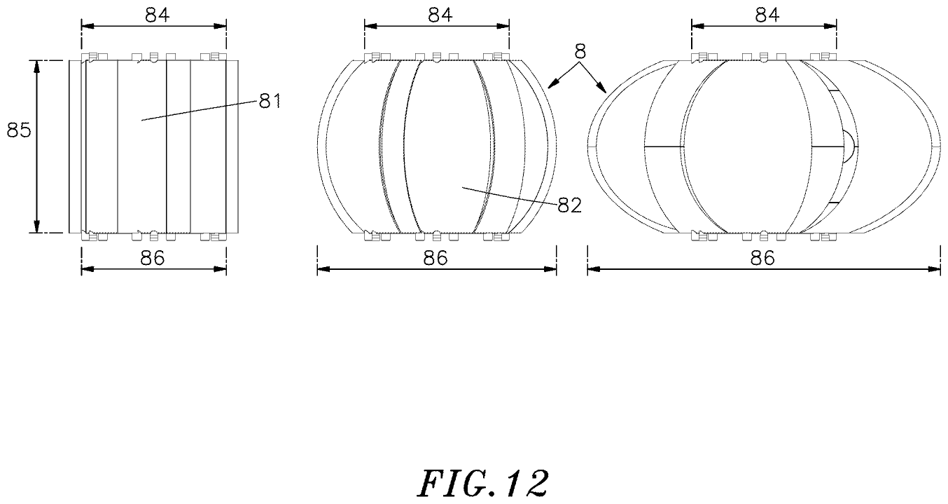

Please refer to FIGS. 6 and 7, which are structural diagrams of first and second fastening disk of the present invention. Two fastening disk are disposed on the bottom side of the first opening of the blades 2, which form a spherical shape, and the top of the second opening of the blades 2, the first fastening disk 3 is disposed on bottom side of the first opening, and connected to each blade 2 through the rotation support column 23, and the second fastening disk 4 is disposed on top side of the second opening, and connected to each blade 2 through the rotation support column 23. The two ball bearings 35 and 45 are mounted on two ends of the rotation support column 23 of each blade 2, respectively, so that each blade 2 is curvedly swingable between the first fastening disk 3 and the second fastening disk 4. With configuration of the first fastening disk 3 and the second fastening disk 4, and a lower cylinder support disk 36 locked at the center of the first fastening disk 3 and an upper cylinder support disk 46 locked at the center of the second fastening disk 4, and a center shaft 61 serially connecting the lower cylinder support disk 36 and the upper cylinder support disk 46 to form a fastening structure, whole structure of the wind power generator becomes firmer and is hard to be damaged when being blown by strong wind. Please refer to FIG. 12. A distance from the first opening to the second opening is defined as an opening interval 85, the largest width of the ball type of the blades 2 in a horizontal direction is defined as a lateral width 86, a ratio of a hollow opening diameter 84 of the impeller formed by the plurality of blades 2 to the lateral width 86 can be in a range of 1:1 to 1:3, so that the inflow air flow can disperse toward the bottom side of the first opening and the hollow opening diameter 84 on the top side of the second opening, thereby preventing from generating back pressure to affect operation of the wind power generator.

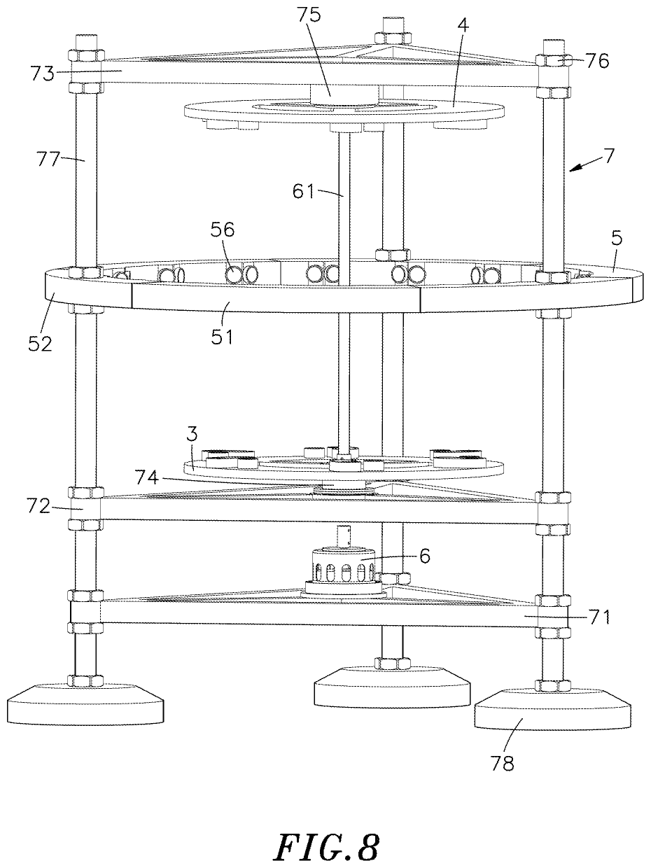

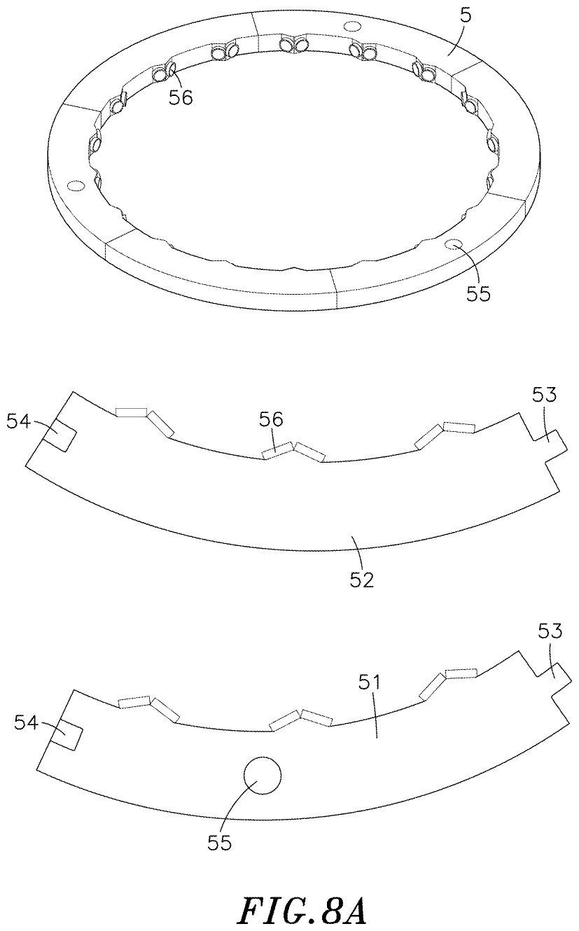

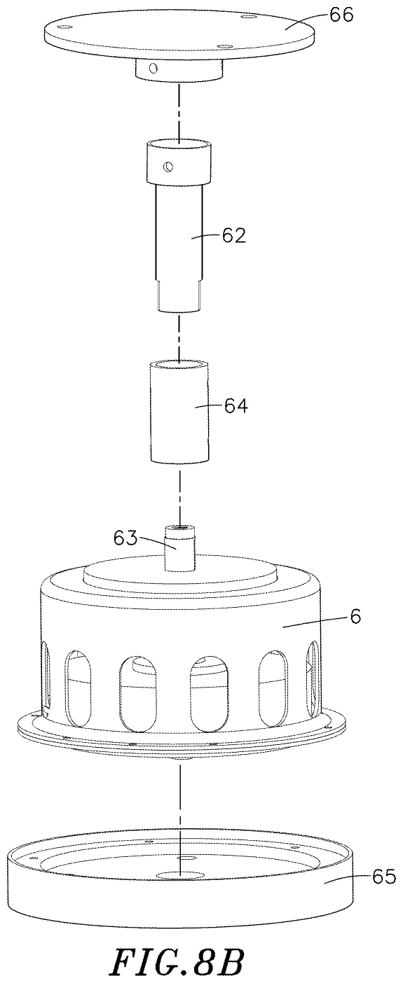

Please refer to FIG. 8, which is a structural diagram of a framework of the wind power generator of the present invention. A machine framework 7 of the wind power generator includes the first fastening disk 3, the second fastening disk 4, the circular band 5, the power generator 6, the center shaft 61, a lower-layer square-tube triangular plate 71, a middle-layer square-tube triangular plate 72, an upper-layer square-tube triangular plate 73, a lower ball bearing holder 74, an upper ball bearing holder 75, the screw rod cylinder 77 and a pedestal disk 78. Please refer to FIGS. 2 and 8A. FIG. 8A is a structural diagram of components of circular band of a wind power generator of the present invention. As shown in FIG. 8A, the machine framework 7 is disposed outside the power generator 6 and the plurality of blades 2, the machine framework 7 includes the circular band 5, which is formed by assembling three first partial-ring plates 51 and three second partial-ring plates 52 in a staggered manner. Each of the first partial-ring plates 51 and the second partial-ring plates 52 has a partial-ring plate protrusion 53 and a partial-ring plate groove 54 formed on two ends thereof, respectively. The partial-ring plate protrusion 53 and the partial-ring plate groove 54 can be assembled through two ends of the first and second partial-ring plates 51 and 52, to form the interlocked circular band 5. Each of the first and second partial-ring plates 51 and 52 includes a fourth magnet group 56 disposed on an inner ring part thereof and having staggered polarities, that is, N-pole magnets and S-pole magnets are arranged in a staggered manner. The screw rod cylinder 77 is inserted through a partial-ring plate hole 55 and locked by a hexagonal screw cap 76, to form the structure of the machine framework 7 of the wind power generator. The open status and the closed status of the plurality of blades 2 of the wind power generator is determined by magnitude of the wind power; when the wind power is lower than the magnetic forces, the plurality of blades 2 of the wind power generator enter the open state to increase the windward areas; when the wind power is larger than the magnetic force, the plurality of blades 2 of the wind power generator enter the closed status; Because no mechanical switch for controlling the blades 2 are disposed inside the wind power generator, the open status and the closed status of the plurality of blades 2 can be determined upon the magnitude of the centrifugal force generated by the wind power. However, the aforementioned structure may cause a problem that the plurality of blades 2 receive wind in a sequential order and if all of the blades 2 are not opened simultaneously when wind blows in a specific direction, uneven forces are applied on the plurality of blades 2, and this problem may cause the machine framework 7 to shake slightly. Therefore, the machine framework 7 is supported by the three screw rod cylinders 77 which are encircled by the circular bands 5, so as to stabilize the machine framework 7, and prevent the shake caused by uneven forces.

Please refer to FIG. 8B, which is a structural diagram of assembly of the wind power generator of the present invention. The power generator uses external wind power to drive the plurality of blades 2, and drive a transmission disk 66 connected to the transmission shaft 62, so that a coupling 64 can drive a driving shaft 63 of the power generator 6 to rotate. The power generator 6 is fixed on a power-generator fastening disk 65 and can convert the mechanical kinetic energy generated by the driving shaft 63 into electric energy, to generate electrical power. The plurality of blades 2 are disposed outside the center shaft 61 and rotated by kinetic energy of wind power, so as to drive the driving shaft 63 to rotate to generate power.

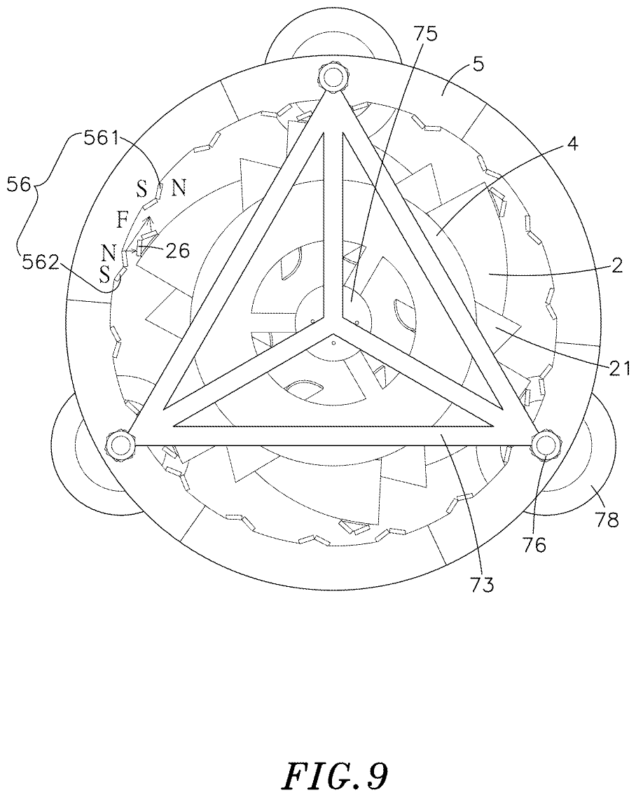

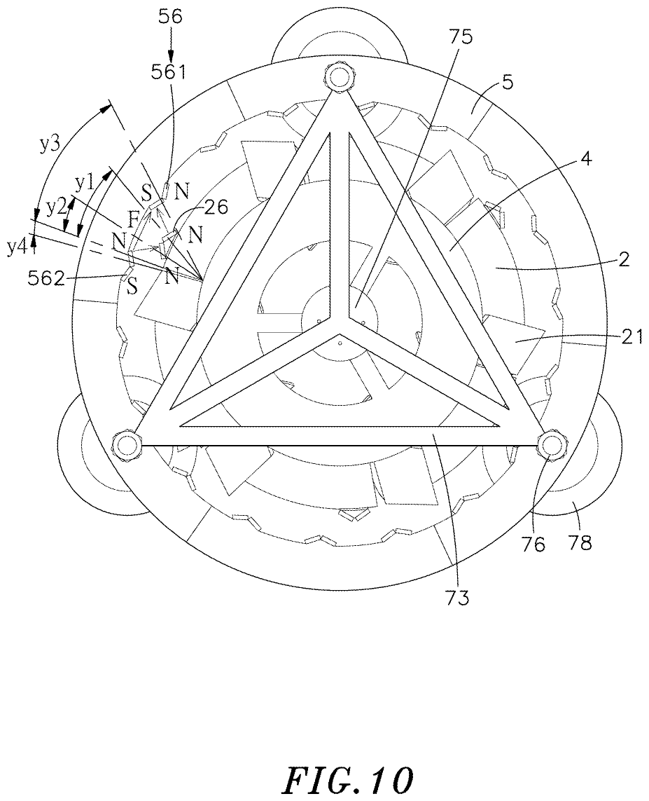

Please refer to FIGS. 9 and 10, which are a top view of the opened impeller and the circular band of the wind power generator and a top view of the closed impeller and the circular band of the wind power generator of the present invention. Each blade 2 has a third magnet group 26 embedded thereon, and the third magnet group 26 include magnets with the same polarities and disposed in horizontal arrangement, that is, the third magnet group 26 includes N-pole magnets arranged in a staggered manner. The circular band 5 on outer side of the wind power generator also has the fourth magnet group 56 disposed on inner side thereof, and the fourth magnet group 56 includes magnets with staggered polarities and disposed in horizontal arrangement, that is, N-pole magnet and S-pole magnet are arranged in a staggered manner, so as to generate a magnetic-field resultant force F of attraction and repulsive force between the third and fourth magnet groups 26 and 56, such as an arrowhead shown in FIG. 9. This configuration is similar to the operational principle of a motor, the magnetic-field resultant force F can be used to assist the blades 2 to start rotation under breeze, and suppress the blades 2 from over-speed rotation under strong wind. As shown in FIGS. 9 and 10, a fourth magnet group 561 located on a higher position is called as a first sub-group, and a fourth magnet group 562 is called as a second sub-group for illustration. However, the persons skilled in the art can set the third magnet group 26 including all N-pole magnets (or all S-pole magnets), and the fourth magnet group 56 including all N-pole magnets (or all S-pole magnets), and then use the repulsive force between the third magnet group 26 and the fourth magnet group 56 to rotate the blades; or, the persons skilled in the art can set the third magnet group 26 including the N-pole magnet and S-pole magnet arranged in a staggered manner, and the fourth magnet group 56 including N-pole magnet and S-pole magnet arranged in a staggered manner, so as to generate the attraction force and repulsive force between the third and fourth magnet groups 26 and 56. It should be noted that the above-mentioned three preferred examples of arranging polarities of the magnets of the third magnet group 26 and the fourth magnet group 56 are within the scope of the present invention, but the present invention is not limited to the preferred examples. The mounting angle of the third magnet group 26 is defined with reference to the center shaft, and an open angle Z during rotation of the blade is in a range of 100 degrees to 140 degrees, and the mounting angle of the fourth magnet group 56 is set correspondingly to the third magnet group 26. The magnets of the third magnet group 26 and the fourth magnet group 56 can be permanent magnets or electromagnets, and the permanent magnet can be made by neodymium-iron-boron material. Please refer to FIG. 10, which is a top view of the closed impeller and the circular band of the wind power generator. The plurality of blades 2 and the circular band 5 on the outer side of the plurality of blades 2 have the third magnet group 26 and the plurality of fourth magnet groups 56 disposed thereon, respectively. In order to speed up rotation of the plurality of blades 2 and improve stability in rotation, each blade 2 has the third magnet group 26 disposed on a lateral side thereof. The circular band 5 outside the plurality of blades 2 includes the fourth magnet groups 56 disposed thereon, and the third magnet groups 26 disposed on the blades 2 are at the same horizontal level (the same height) and arranged with equal interval. In order to use the attraction force between magnets, the third magnet groups 26 disposed on the blades are the same polarities, and the fourth magnet groups 56 mounted on the circular band 5 have different polarities from that of the third magnet group 26. In this condition, a magnet (such as N-pole magnet) of the third magnet group 26 is disposed on the position which is on right side of a part with reference to the right of the lateral side (baseline) of the blade by an angle y1 in a range of 10 degrees to 20 degrees, and faces the fourth magnet group 561 at the higher position, and a magnet (such as S-pole magnet) the fourth magnet group 561 is disposed at a position which is on left side of the part with reference to the right of the lateral side of the blade by an angle y3 in a range of 15 degrees to 30 degrees, so that these magnets can face to each other, and the magnets are mounted on the outer side of the plurality of blades 2 by equivalent angles, so that the corresponding magnets can attract each other. In order to use the repulsive property of the magnets, all of the permanent magnet or the magnet disposed on the plurality of blades 2 have the same polarity, and the permanent magnets or magnets disposed on the circular band 5 have polarities the same as that of the magnets on the plurality of blades 2. In this condition, a magnet (such as N-pole magnet) of the third magnet group is disposed on the position which is on left side of a part with reference to the right of the lateral side (baseline) of the blade by an angle y2 in a range of 5 degrees to 15 degrees, and faces the fourth magnet group 562 at the lower position, and a magnet (such as N-pole magnet) the fourth magnet group 562 is disposed at a position which is on right side of the part with reference to the left of the lateral side of the blade by an angle y4 in a range of 0 degrees to 10 degrees, so that these magnets can face to each other, and the magnets are mounted on the outer side of the plurality of blades 2 by equivalent angles, so that the corresponding magnets can repel each other. By using the attraction force and the repulsive force between the magnets, the left and right magnets of each third magnet group 26 are disposed on the outer side of the plurality of blades 2 with reference to the right of the lateral side of the blade 2 by the angle y1 in a range of 5 degrees to 15 degrees, and by the angle y2 in a range of 10 degrees to 20 degrees, respectively, and the left and right magnets of the third magnet group 26 are permanent magnets or the electromagnet with the same polarities. The left magnets of the fourth magnet group 561 mounted on the circular band 5 have polarities opposite to that of the third magnet group 26 on the blade 2, and each of the left magnets of the fourth magnet groups 561 is disposed by an angle y3 in a range of 15 degrees to 30 degrees in the attraction direction. The right magnets of the fourth magnet group 562 mounted on the circular band 5 has polarities the same as that of the third magnet groups 26 of the plurality of blades 2, and each of the right magnets is disposed by the angle y4 in a range of 0 degree to 10 degrees in the repulsive direction. Multiple magnets can be mounted on the circular band 5. In this condition, the permanent magnets or electromagnets on the outer sides of the plurality of blades 2 can be disposed at the same level horizontally as that of the permanent magnets or electromagnets on the circular band 5, and the sizes, magnetic forces and amounts of the permanent magnets or the electromagnets on the circular band 5 and the plurality of blades 2 are determined upon the actual size of the wind power generator.

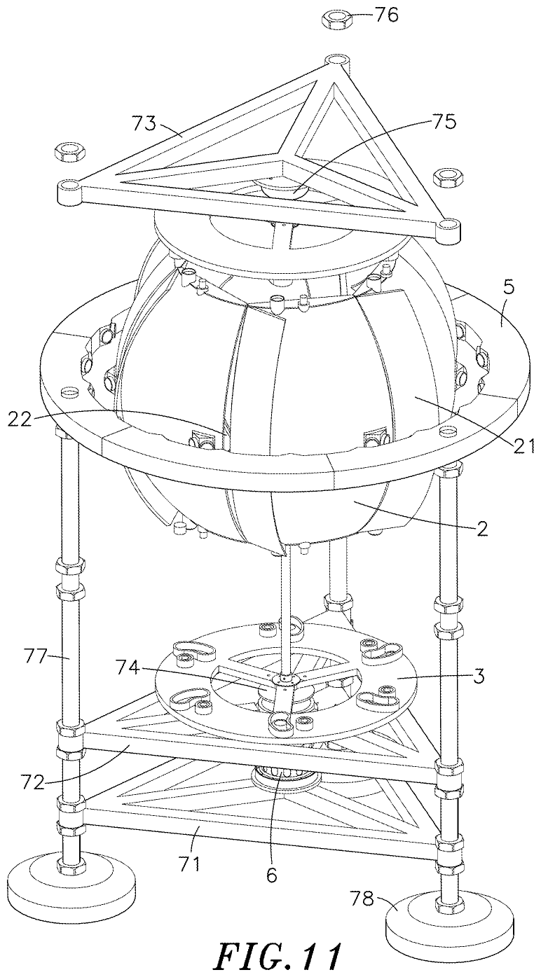

Please refer to FIGS. 2 to 11. FIG. 11 is an exploded view of a wind power generator of the present invention. With reference to a vertical center of the blade 2 as a fulcrum, the lateral side of the blade 2 (such as the left side of the blade) in rotation forward direction is heavier than the right side of the blade 2, the plurality of blades 2 can be expanded to a spherical expansion shape and rotated unidirectionally; when there is no wind (that is, the wind power generator is not rotated) or only breeze in environment, the configuration of left and right sides of the blade 2 having different weights makes the left sides of the plurality of blades 2 inclined in the central direction, and it facilitates the blade 2 to capture wind power, so as to form an inner-outer drag-lift ball type which can generate higher centrifugal force during high-speed rotation of the plurality of blades 2. By the centrifugal force, the left sides of the plurality of blades 2 (that is, the left side of the blade 2) in the rotation forward direction are slowly moved away from the central point of the plurality of blades 2, and eventually, the plurality of blades 2 enter the ball-type closed status. Therefore, the blades 2 can be in one of the drag-lift type shape, half drag-lift type shape and ascent type shape to receive wind power. When wind power becomes weak, the rotational centrifugal force become lower, the left sides of the plurality of blades 2 in the rotation forward direction are slowly moved to the central point of the plurality of blades 2, and the plurality of blades 2 become the drag-lift type shape for windward rotation again. With above-mentioned structure, all blades 2 can be automatically opened or closed simultaneously for long periods of time, so that the rotation stability of the blades 2 can be improved because of not being affected by strength balance, performance, lifetime and weight of spring, hydraulic or pneumatic retractable link rod; furthermore, simple structure can make the entire wind power generator have light weight and high-speed rotation, so maintenance of the wind power generator can be simpler and more efficient.

The vertical axial wind power generator of the present invention includes six blade 2, and the plurality of blades 2 are assembled independently, so one blade 2 can be replaced individually for maintenance; in contrast, the conventional offshore wind power generator with large-sized cross-type blade must replace whole group of blade for maintenance. The blade 2 can be an outwardly-convex curve plate. Furthermore, each of the plurality of blades 2 has the outer wind collection vane 21 mounted on the outer side of the most front end thereofin rotation forward direction (such as left direction), and the inner wind collection vane 22 mounted on inner side thereof; the left side of the blade 2 in the rotation forward direction is heavier than the right side of the blade 2, and shape and weight of the left side of the blade 2 is larger than that of right side of the blade 2, so as to facilitate an unidirectional rotation. Because of the weight difference between left and right sides of the blade 2, the heavier left side is inclined to the central point of the plurality of blades 2, the blades 2 can form the spherical type in which the blade 2 can receive wind power to rotate more effortlessly. Furthermore, the left-side part of the blade 2 has a streamlined shape, and the groove on the inner side of the blade 2 is in a high wind-resistance shape, so the blade 2 can receive wind power very effortlessly to self-rotate. The side of the blade 2 in the rotation forward direction (left side of the blade) has a streamlined shape, and the wind capturing angles of the outer wind collection vane 21 and the inner wind collection vane 22 on the inner side and outer side of the blade 2 are set as an outward expansion angle and an outward extension angle relative to the streamlined shape from left side to right side of the blade 2. Preferably, the basic angle of the inner wind collection vane 22 on the inner side of left side of the blade 2 and the basic angle of the outer wind collection vane 21 of the outer side of the blade 2 can be set in a range of 10 degrees to 60 degrees, respectively; during rotation, the drag-lift force and ascension force can be used to enable the wind power generator to rotate at a low speed to a high speed, and self-rotate at a stable speed eventually. The rotation support column 23 and the rotation column 24 are disposed on center parts of top and bottom of the blade 2 and configured to support the blade 2, and the rotation column 24 can be rotated in a rotation forward direction. Each blade 2 is mounted with the two ball bearings 35 and 45, to enable the blade 2 to rotate effortlessly. The ball bearings on the top and bottom of the blade 2 can be mounted on the first and second fastening disks 3 and 4, so that the fastening disks 3 and 4 and the center shaft 61 of the power generator 6 can be rotated together. The fastening disks 3 and 4 include rotation support column holes 32 and 42 configured to mount the bearing members on the center part of the blade 2 on the top and bottom of the blade 2, and the curved angle-limiting grooves 31 and 41 configured to mount the bearing members on the side in the rotation forward direction. Furthermore, the rotation support column holes 32 and 42 and the angle-limiting grooves 31 and 41 on the fastening disks 3 and 4 can be grooves. The rotation support column holes 32 and 42 can enable the blades 2 to rotate effortlessly, and the angle-limiting grooves 31 and 41 can be used to set a movement range of each blade 2, for example, the movement range defines an open angle and a closed angle, so that all blades 2 can be opened or closed at the same time. When the left side of the blade 2 is located in the angle-limiting groove near the central point of the blades 2, the blade 2 can have the maximum open angle and the inner side of the blade 2 can receive wind most effortlessly. When the left side of the blade 2 is located in the angle-limiting grooves 31 and 41 furthest away from the central points of the blade 2, the blades 2 enter the closed status and the inner side of the blade 2 does not receive wind. The length, width and curvature of each of the angle-limiting grooves 31 and 41 and the diameter of each of the rotation support column holes 32 and 42 can be varied according to the sizes of various bearings. The lengths, widths and curvatures of the angle-limiting grooves 31 and 41 can determine the movement range of the blade 2, the movement range is expanded with reference to the centers of the rotation support column holes 32 and 42 by an angle in range of 5 degrees to 50 degrees. The present invention is characterized that the plurality of blades 2 can be automatically opened and closed under a rotation speed without using other mechanical switch, the centrifugal force generated under high-speed rotations of the plurality of blades 2 can make the blades 2 become ball type which is in a safe status to prevent from withstanding excessive wind power. However, if the plurality of blades 2 early becomes the ball type in the closed status subject to the centrifugal force before reaching the predetermined rotation speed, the rotation speed of the plurality of blades 2 of the ball type cannot be increased and it is possibly unable to achieve the predetermined power generation; in order to prevent the blades 2 of the ball type from entering the closed status and enable the blades 2 to continuously keep the windward rotation shape before the rotation reaches the predetermined rotation speed, magnets 34 and 44 can be embedded in the angle-limiting grooves 31 and 41 of the first fastening disk 3 and the second fastening disk 4 near the central axis of the wind power generator, and the magnets 34 and 44 can attract the magnets embedded in two ends of the rotation column 24 of the blade 2, and this attract force is used to resist the centrifugal force generated by rotation. When the rotation speed of the wind power generator becomes slow, the centrifugal force is smaller than the magnetic force, the blades 2 can enter the windward rotation open status again, the attraction force and the repulsive force of the magnets 34 and 44 on the fastening disks 3 and 4 and the blades 2 can be used to make the wind power generator continuously keep in the open state under low rotation speed; at this time, the wind power generator continuously rotates, and the rotation speed increases stably and slowly or does not increase, and the power generation will be reduced. When the rotation speed of the wind power generator does not reach the predetermined rotation speed, the blades 2 must be kept in the windward rotation shape anytime. Magnets 25 can be disposed on parts, near the central point of the blades 2, of the angle-limiting grooves 31 and 41 of the fastening disks 3 and 4, or disposed on outer sides of the angle-limiting grooves 31 and 41 away from the central point of the blades 2, or disposed on the rotation column 24, where the bearing can be mounted, of the blade 2 in rotation forward direction. In order to generate repulsive force, the magnets 33 and 43 with the same polarities are disposed in the angle-limiting grooves 31 and 41 of the fastening disks 3 and 4 and on the outer side, and on the rotation column 24, where the bearing is mounted, of the blade 2 in the rotation forward direction. In order to generate the attraction force, the magnets with different polarities can be mounted in the angle-limiting grooves 31 and 41 of the fastening disks 3 and 4 near the center shaft 61 of the power generator 6, and these magnets can be disposed longitudinally or alongside. Under effect of the attraction force and the repulsive force of the magnets, the blade 2 can enter windward status before the wind power generator reaches the predetermined rotation speed. Furthermore, each of the angle-limiting grooves 31 and 41 of the first fastening disk 3 and the second fastening disks 4 on the top of the blade 2 can has a drain hole formed thereon for draining.

Please refer to FIG. 12, which is a schematic view of an elliptic impeller of the wind power generator of the present invention. A ratio 8 of an opening diameter to a lateral width of the impeller of the blades 2 can be used to define different elliptical types including, in the order from left to right, a cylinder type 81, a ball type 82, and a flat elliptical type 83. The blades 2 form an elliptical type when being closed, and a first opening can be formed on an end of the blades 2; in this embodiment, the first opening is the opening formed by upper edges of the blades 2 being closed. A second opening can be formed on other end of the blades 2; in this embodiment, the second opening is the opening formed by the lower edges of the blades 2 being closed. The first or second opening has the hollow opening diameter 84, and the distance from the first opening to the second opening is defined as the opening interval 85, which is set as a fixed value. The largest width of the elliptical type formed by the blades 2 in a horizontal direction is defined as the lateral width 86. D is defined as the hollow opening diameter 84, L is defined as the lateral width 86, R is defined as the predetermined ratio, and D and L can be substituted into the following formula to obtain R:

R=D/L

When the predetermined ratio R is higher than one, it indicates that the impeller becomes a hourglass type in a concave shape, and inflow air flow may generate backpressure to affect operation of the wind power generator; when the predetermined ratio R is lower than 1, it indicates that the impeller becomes an elliptical type in a convex shape, the inflow air flow disperses towards the hollow opening diameter of the first opening (the lower opening) and the second opening (the upper opening), so as to prevent from generating back pressure to affect operation of the wind power generator. Preferably, the predetermined ratio R can be in a range of 1:1 to 1:3, and when the predetermined ratio R is close to 1:1, it indicates that the shape formed by the blades is close to the cylinder type; when the predetermined ratio R is close to 1:1.5, it indicates that the shape formed by the blades is close to the ball type; in contrast, when the predetermined ratio R is close to 1:3, it indicates that the shape formed by the blades is close to the flat elliptical type.

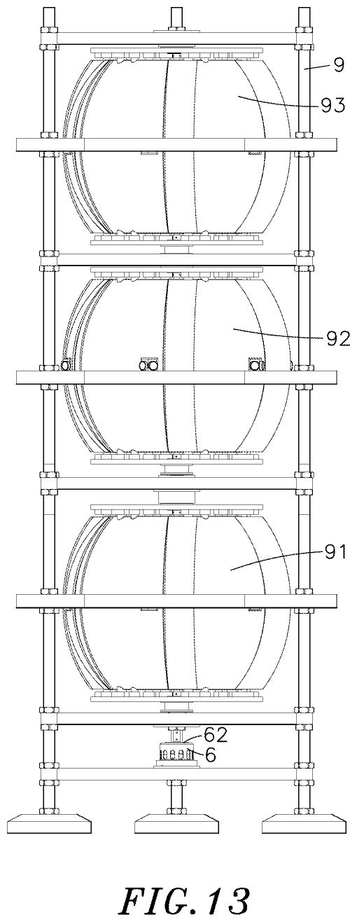

Please refer to FIG. 13, which is a structural diagram of the plurality of windmill unit serially connected on the transmission shaft of the wind power generator of the present invention. As shown in FIG. 13, a plurality of windmill units 9 are serially connected to the transmission shaft 62 of the power generator 6 in a vertical direction, and in this embodiment, the plurality of windmill units 9 includes a first windmill impeller unit 91, a second windmill impeller unit 92 and a third windmill impeller unit 93, to form a high-torque wind power generator. The torque generated by the serially-connected windmill impeller units can be used to form a large-sized wind power generator to drive high-power power generation module to generate more power generation; compared with the conventional large-sized wind power generator with cross-shaped fan blades, the high torque relates to large surface areas of the blades in the ball type and cylinder type of the windmills of the present invention, so the ball type of wind power generator and the cylinder type of wind power generator connected in series can increase power generation in the same area, and the configuration can be performed by a central axis and an enlarged-type power generator. The wind power generator of this embodiment has advantages of high power generation efficiency, low manufacturing cost, high safety and easy to install.

According the disclosed contents shown in FIG. 2 to 13, the present invention provides a vertical axial wind power generator, and mainly provides a small and medium-sized wind power generator, and the small and medium-sized wind power generator comprises a plurality of blades disposed thereon and rotated in a horizontal direction, the horizontal blades can be operated with less limitation in space and environment, and can be rotated by low wind power; when the wind power is lower than the attraction force of the magnets, the plurality of blades enters the open status to increase windward area; when wind power becomes higher than the magnetic force, the plurality of blades are closed to form the ball type, the plurality of blades can have effect of strengthening torque, and the windward area can be minimized, so that the rotation speed of the wind power generator can be reduced naturally; next, when wind becomes stable, the plurality of blades can return to the open state. As a result, the blades of the wind power generator of the present invention can be adjusted to meet the change of the wind power, thereby achieving the purpose of protecting the wind power generator mechanism and extending lifetime of the wind power generator. Furthermore, each blade has the magnet group mounted thereon and having the same polarities, and the circular band outside the wind power generator has the magnet group having staggered polarities, and the circular band can have a plurality of magnet groups arranged thereon, so that the magnetic-field resultant force of the attraction force and repulsive force can be generated between the magnets of the circular band and the blades to facilitate the plurality of blades to start rotation under breeze. The above-mentioned operation is similar to the operational principle of a motor.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A vertical axial wind power generator, comprising:
a power generator using wind power to drive a plurality of blades, to drive a transmission shaft to generate electrical power;
the plurality of blades disposed outside the transmission shaft of the power generator, and rotated by the wind power to drive the transmission shaft, wherein a first opening is formed on ends of the plurality of blades, and a second opening is formed on other ends of the plurality of blades;
a first fastening disk disposed on top side of the first opening, and pivotally connected to the plurality of blades through a plurality of rotation support columns and a plurality of rotation columns, respectively;
a second fastening disk disposed on a bottom side of the second opening, and pivotally connected to the plurality of blades through the plurality of rotation support columns and the plurality of rotation columns, respectively, and each of the plurality of blades curvedly swingable in an angle-limiting groove between the first fastening disk and the second fastening disk.

2. The vertical axial wind power generator according to claim 1, wherein the plurality of blades form a ball type when being closed, and each of the plurality of blades has the first opening formed on an end thereof, and the second opening formed on other end thereof, the first opening or the second opening has a hollow opening diameter, a distance from the first opening to the second opening is an opening interval, a largest width of the plurality of blades of the ball type in a horizontal direction is a lateral width, a predetermined ratio of the hollow opening diameter to the lateral width is defined to make inflow air flow disperse toward the bottom side of the first opening and the top side of the second opening, and the preset ratio is in a range of 1:1 to 1:3, and when the predetermined ratio is close to 1:1, it indicates that an elliptical body formed by the plurality of blades is close to a cylinder shape, and when the predetermined ratio is close to 1:1.5, it indicates that the elliptical body is close to the ball type, and when the predetermined ratio is close to 1:3, it indicates that the elliptical body is close to a flat elliptical body.

3. The vertical axial wind power generator according to claim 1, further comprising a machine framework disposed outside the power generator and the plurality of blades, wherein the machine framework comprises a circular band formed and assembled by three first partial-ring plates and three second partial-ring plates in a staggered manner, each of the three first partial-ring plates or the three second partial-ring plates comprises a partial-ring plate protrusion and a partial-ring plate groove formed on two ends thereof, respectively, and the partial-ring plate protrusions and the partial-ring plate grooves on two ends of the plurality of first and second partial-ring plates are assembled to form the interlocked circular band, each of the first and second partial-ring plates comprises a plurality of fourth magnet groups having staggered polarities and disposed on an inner ring part thereof.

4. The vertical axial wind power generator according to claim 1, wherein each of the plurality of blades comprises an inner wind collection vane disposed on an inner side thereof and configured to increase a windward area when the plurality of blades is opened, an angle between the inner wind collection vane and the inner side of the blade is in a range of 10 degrees to 60 degrees;
wherein each of the plurality of blades comprises an outer wind collection vane disposed on an outer side thereof and configured to increase the windward area and a holding time when the plurality of blades are closed, and an angle between the outer wind collection vane and the outer side of the blade is in a range of 10 degrees to 60 degrees, the inner wind collection vane and the outer wind collection vane are disposed on a left-side part of the blade, and shape and weight of the left-side part of each of the plurality of blades is larger and higher than that of a right-side part of each of the plurality of blades, to form an unidirectional rotation.

5. The vertical axial wind power generator according to claim 1, wherein each of the plurality of blades comprises a third magnet group embedded thereon and having the same polarities, and a circular band outside the wind power generator comprises a plurality of fourth magnet groups disposed thereon and having staggered polarities, to generate attraction force and repulsive force between the third magnet group and the plurality of fourth magnet groups, to assist the plurality of blades to rotate and suppress the plurality of blades from generating over-speed rotation.

6. The vertical axial wind power generator according to claim 5, wherein in order to generate the attraction force and the repulsive force between the third magnet group and the plurality of fourth magnet groups, the right and left magnets of each of the third magnet groups are disposed on outer side of one of the plurality of blades by an angle in a range of 5 degrees to 15 degrees and by an angle in a range of 10 degrees to 20 degrees with reference to the right of a lateral side of the corresponding blade as a baseline, respectively, and the left and right magnets are permanent magnets or electromagnets with the same polarities.

7. The vertical axial wind power generator according to claim 5, wherein in order to generate the attraction force between the third magnet group and the plurality of fourth magnet groups, a N-pole magnet of the third magnet group is mounted on the position which is on right side of a part with reference to the right of the lateral side of the blade as a baseline by an angle in a range of 10 degrees to 20 degrees, and faces the two fourth magnet groups mounted on the inner side of the circular band;
wherein a S-pole magnet of a first sub-group, on a higher position, of the fourth magnet group is disposed at a position which is on left side of the part with reference to the right of the lateral side of the blade by an angle in a range of 15 degrees to 30 degrees, and the N-pole magnet and the S-pole magnet face to each other, and the magnets mounted on the circular band are arranged by equivalent angles to facilitate the magnets to attract each other.

8. The vertical axial wind power generator according to claim 5, wherein in order to generate the repulsive force between the third magnet group and the plurality of fourth magnet groups, a N-pole magnet of the third magnet group is disposed on the position which is on left side of a part with reference to the right of the lateral side of the blade as a baseline by an angle in a range of 5 degrees to 15 degrees, and faces a second sub-group, located on a lower position, of the plurality of fourth magnet groups, and a N-pole magnet of the fourth magnet group on the lower position is disposed at a position which is on right side of the part with reference to the left of the lateral side of the blade by an angle in a range of 0 degrees to 10 degrees and the N-pole magnets faces to each other, and the magnets mounted on the circular band are arranged by equivalent angles to facilitate the magnets to repel each other.

9. The vertical axial wind power generator according to claim 1, wherein each of the first fastening disk and the second fastening disk comprises a rotation support column hole and the angle-limiting groove formed thereon and pivotally connect to the rotation support column and the rotation column, respectively, wherein a length, width and curvature of the angle-limiting groove defines a movement range of the corresponding one of the plurality of blades, and the movement range is between 5 degrees to 50 degrees extended with reference to a center of the rotation support column hole.

10. The vertical axial wind power generator according to claim 9, wherein the rotation column comprises a magnet embedded on a top thereof, and each of the first fastening disk and the second fastening disk comprises a magnet embedded thereon, in the angle-limiting groove of each of the first fastening disk and the second fastening disk, a first magnet is embedded in an outer hole near an outer circumference and configured to repel the magnet embedded on the rotation column of the blade, a second magnet is embedded in an inner hole near a center of each of the first fastening disk and the second fastening disk and configured to attract the magnet on the rotation column of the blade, and the repel force and attraction force generated by the first and second magnets are used to assist the plurality of blades to rotate and suppress the plurality of blades from generating over-speed rotation, so as to make the plurality of blades automatically open or close stably at the same time.
